(19) United States
(12) Patent Application Publication
(10) Pub. No.: US 2013/0314818 A1
(43) Pub. Date: Nov. 28, 2013

(54) RECORDING HEAD AND DISK DEVICE INCLUDING THE SAME

(71) Applicants: Takuya Maatsumoto, Tokyo (JP); Kenichiro Yamada, Tokyo (JP); Noayuki Narita, Tokyo (JP)

(72) Inventors: Takuya Maatsumoto, Tokyo (JP); Kenichiro Yamada, Tokyo (JP); Noayuki Narita, Tokyo (JP)

(21) Appl. No.: 13/659,735

(22) Filed: Oct. 24, 2012

(30) Foreign Application Priority Data
May 25, 2012 (JP) 2012-120207

(51) Int. Cl. G11B 5/187

(52) U.S. Cl. CPC G11B 5/187
USPC 360/99.08; 360/125.03; 360/234.3

(57) ABSTRACT

A recording head includes a main magnetic pole generating a recording magnetic field in a direction perpendicular to a recording medium, a write shield magnetic pole facing a trailing side of the main magnetic pole, a recording coil exciting a magnetic flux in a magnetic circuit, and a spin torque oscillator provided between the main magnetic pole and the write shield magnetic pole. The main magnetic pole includes a trailing side end surface that faces the spin torque oscillator and is tilted toward a leading side of the recording head with respect to the direction perpendicular to the recording medium, and the spin torque oscillator has layers with tilted surfaces that are substantially in parallel with the trailing side end surface.

### CROSS-REFERENCE TO RELATED APPLICATION(S)

This application is based upon and claims the benefit of priority from Japanese Patent Application No. 2012-120207, filed on May 25, 2012; the entire contents of (if multiple applications, all of) which are incorporated herein by reference.

### FIELD

Embodiments described herein relate to a recording head for perpendicular magnetic recording which is used for a disk device, and a disk device including the recording head.

### BACKGROUND

A disk device, for example a magnetic disk device, includes a magnetic disk, a spindle motor, and a magnetic head. The magnetic disk is disposed in a case. The spindle motor supports and rotationally drives the magnetic disk. The magnetic head reads/writes data to/from the magnetic disk. The magnetic head has a slider attached to a suspension, and a head part provided in the slider. The head part is configured with a recording head for writing and a reproducing head for reading.

In recent years, a magnetic head for perpendicular magnetic recording has been proposed to further increase the recording density and capacity of the magnetic disk device and reduce the size thereof. In a magnetic head of this type, a recording head has a main magnetic pole, a write shield magnetic pole, and a coil. The main magnetic pole generates a perpendicular magnetic field. The write shield magnetic pole is arranged on a trailing side of the main magnetic pole with a write gap interposed between the main magnetic pole and the write shield magnetic pole, and closes a magnetic path between the magnetic disk and the write shield. The coil serves to pass a magnetic flux through the main magnetic pole. In addition, a high frequency assist head has been proposed in which a high frequency oscillator, for example a spin torque oscillator, is provided between a medium side end part of the write shield magnetic pole and the main magnetic pole and a current flows to the high frequency oscillator through the main magnetic pole and the write shield magnetic pole.

In the magnetic head mentioned above, the spin torque oscillator that is provided between the main magnetic pole and the write magnetic shield pole is provided in parallel to the film growth direction. That is, the spin torque oscillator is provided substantially perpendicular to an air bearing surface (ABS) of the magnetic head. When the spin torque oscillator oscillates, a high-frequency magnetic field (c-Hac) is generated as a leakage magnetic field from the spin torque oscillator. Due to the direction of rotation magnetization of the spin torque oscillator, the rotation direction of a c-Hac generated on a main magnetic pole facing side of the spin torque oscillator is opposite to the rotation direction of a c-Hac generated on the write shield magnetic pole facing side of the spin torque oscillator. Due to the rotation directions of the c-Hacs, the c-Hac generated on the main magnetic pole side works to make favorable a state of a disk recording layer that depends on the magnetic field from the main magnetic pole, which is known as magnetization reversal state.

### BRIEF DESCRIPTION OF THE DRAWINGS

FIG. 1 is a perspective view illustrating a hard disk drive (hereinafter, referred to as HDD) according to a first embodiment.

FIG. 2 is a side view illustrating a magnetic head and a suspension in the HDD.

FIG. 3 is an enlarged cross-sectional view illustrating a head part of the magnetic head.

FIG. 4 is a perspective view schematically illustrating a recording head of the magnetic head.

FIG. 5 is an enlarged cross-sectional view illustrating an ABS side end part of the recording head.

FIG. 6 is the side view of the ABS side end part of the recording head from the perspective of a leading end side of a slider.

FIG. 7 is a plan view of the recording head from the perspective of the ABS side.

FIGS. 8A and 8B are flow diagrams illustrating a manufacturing process of the recording head.

FIGS. 9A and 9B are flow diagrams illustrating a manufacturing process of the recording head.

FIGS. 10-13 are different views of the recording head at various steps of the manufacturing process of the recording head.

FIG. 14 is a graph illustrating the relationship between an incline angle of a spin torque oscillator of the recording head and a high-frequency magnetic field intensity.

FIG. 15 is a graph illustrating the relationship between an incline angle of a main magnetic pole and a bit error rate.

FIG. 16 is a graph illustrating the degree of signal output improvement at a plurality of the oscillation frequencies of the magnetic head according to an embodiment with respect to a magnetic head according to a comparative example.

FIG. 17 is a cross-sectional view illustrating a recording head of a magnetic head of the HDD according to a second embodiment.

FIG. 18 is a perspective view schematically illustrating the recording head of the magnetic head of the HDD according to the second embodiment.

FIG. 19 is a side view of the ABS side end part of the recording head from the perspective of the leading end side of the slider.

FIG. 20 is a plan view of the recording head from the perspective of the ABS side.

FIG. 21 is a cross-sectional view illustrating a recording head of a magnetic head of the HDD according to a third embodiment.

FIG. 22 is a perspective view schematically illustrating the recording head of the magnetic head of the HDD according to the third embodiment.

FIG. 23 is a side view of the ABS side end part of the recording head from the perspective of the leading end side of the slider.

FIG. 24 is a plan view of the recording head from the perspective of the ABS side.

FIG. 25 is a cross-sectional view illustrating a recording head of a magnetic head of the HDD according to a fourth embodiment.

FIG. 26 is a perspective view schematically illustrating the recording head of the magnetic head of the HDD according to the fourth embodiment.

FIG. 27 is a side view of the ABS side end part of the recording head from the perspective of the leading end side of the slider.

FIG. 28 is a plan view of the recording head from the perspective of the ABS side.

### DETAILED DESCRIPTION

A recording head disclosed herein includes a main magnetic pole that generates a recording magnetic field in a direction perpendicular to a recording layer of a recording medium, a write shield magnetic pole that faces a trailing side of the main magnetic pole through a write gap interposed therebetween, a recording coil that excites a magnetic flux in a magnetic circuit formed by the main magnetic pole and the write shield magnetic pole, and a spin torque oscillator that is provided between a tip part of the main magnetic pole on the recording medium side and the write shield magnetic pole and that generates a high frequency magnetic field. The tip part of the main magnetic pole includes a trailing side end surface facing the spin torque oscillator, the trailing side end surface that forms an oblique angle with respect to the direction perpendicular to the recording layer of the recording medium, and the spin torque oscillator is arranged with one or more layers having surfaces that are substantially in parallel with the trailing side end surface.

Hereinafter, various embodiments will be described in detail with reference to the accompanying drawings.

### First Embodiment

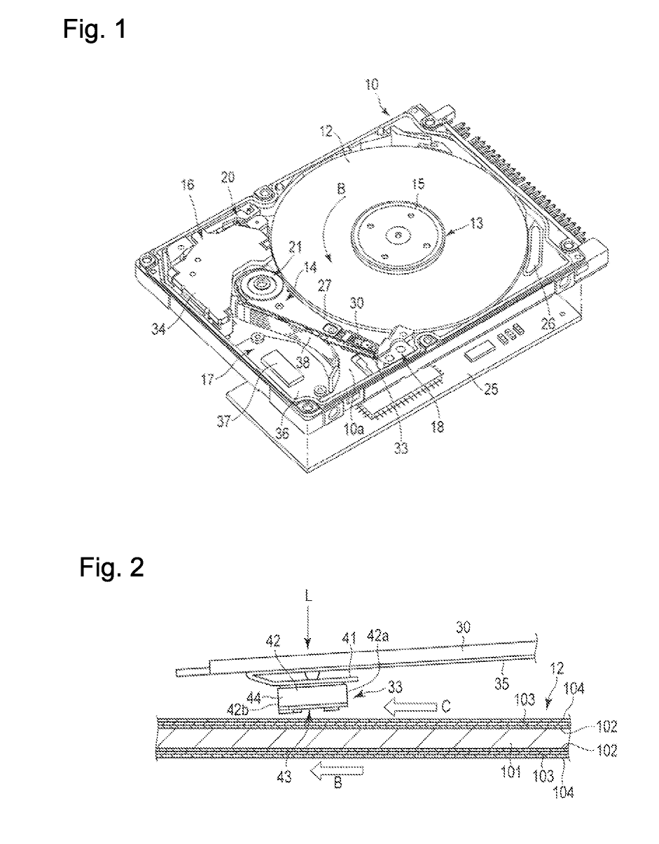

FIG. 1 illustrates an internal structure of an HDD according to a first embodiment with its top cover off. FIG. 2 illustrates a magnetic head in a flying state. As illustrated in FIG. 1, the HDD includes a case 10. The case 10 includes a base 10a in the form of a rectangular box that is open-topped and a top cover (not illustrated) in the form of a rectangular plate. The top cover is screwed on the base by plural screws so as to close a top opening of the base. As a result, the inside of the case 10 is kept airtight, and air flows between the inside and the outside only through a breather filter 26.

On the base 10a, a magnetic disk 12 as a recording medium and a mechanism part are provided. The mechanism part includes a spindle motor 13, a plurality of (for example, two) magnetic heads 33, a head actuator 14, and a voice coil motor (hereinafter, referred to as VCM) 16. The spindle motor 13 supports and rotates the magnetic disk 12. The magnetic heads 33 record information to and reproduce information from the magnetic disk 12. The head actuator 14 supports the magnetic heads 33 in a movable manner with respect to surfaces of the magnetic disk 12. The VCM 16 revolves and positions the head actuator. On the base 10a, a ramp load mechanism 18, a latch mechanism 20, and a board unit 17 are provided. The ramp load mechanism 18 holds the magnetic heads 33 at positions distanced from the magnetic disk 12 when the magnetic heads 33 are moved to an outermost periphery of the magnetic disk 12. The latch mechanism 20 holds the head actuator 14 at an evacuation position when the HDD is affected by a jolt and the like. The board unit 17 has electronic components such as a preamplifier, a head integrated circuit (IC), and the like mounted thereon.

A control circuit board 25 is screwed on an outer surface of the base 10a, and is positioned facing a bottom wall of the base 10a. The control circuit board 25 controls the operations of the spindle motor 13, the VCM 16, and the magnetic heads 33 via the substrate unit 17.

As illustrated in FIG. 1, the magnetic disk 12 is fit to a hub of the spindle motor 13 in a coaxial manner and clamped and fixed to the hub by a clamp spring 15, which is screwed to an upper end of the hub. The magnetic disk 12 is rotationally driven in the direction of an arrow B at a predetermined rate by the spindle motor 13 used as a drive motor.

The head actuator 14 includes a bearing part 21 and a plurality of arms 27. The bearing part 21 is fixed on the bottom wall of the base 10a. The arms 27 extend from the bearing part 21. The arms 27 are positioned in parallel to the surfaces of the magnetic disk 12 and at intervals therebetween, and extend in the same direction from the bearing part 21. The head actuator 14 includes elastically deformable suspensions 30 each in the shape of an elongated plate. Each suspension 30 is configured with a plate spring and has a proximal end fixed to a distal end of its corresponding arm 27 by spot welding or adhesion. Each suspension 30 extends from its corresponding arm. Each suspension 30 may be formed with its corresponding arm 27 in an integrated manner. At an end of the extended part of each suspension 30, its corresponding magnetic head 33 is supported. Each arm 27 and its corresponding suspension 30 configure a head suspension, and the head suspension and its corresponding magnetic head 33 configure a head suspension assembly.

As illustrated in FIG. 2, each magnetic head 33 has a substantially-cuboid-shaped slider 42 and a head part 44 for recording and reproduction that is provided at an outflow end (trailing end) of the slider. Each magnetic head 33 is fixed to a gimbal spring 41 provided at a distal part of the suspension 30. To each magnetic head 33, a head load L directed toward the surface of the magnetic disk 12 is applied due to the elasticity of the suspension 30. The two arms 27 are positioned in parallel to each other at a predetermined interval therebetween, and the suspensions 30 attached to the arms and the magnetic heads 33 face each other on both sides of the magnetic disk 12.

Each magnetic head 33 is electrically connected to a main flexible printed circuit (FPC) 38, which is described below, via a relay flexible printed circuit board (hereinafter, referred to as relay FPC) 35 fixed on the suspension 30 and the arm 27.

As illustrated in FIG. 1, the board unit 17 has the FPC main part 36 formed with a FPC board, and a main FPC 38 extending from this FPC main part 36. The FPC main part 36 is fixed on the bottom surface of the base 10a. On the FPC main part 36, electronic components including the preamplifier 37 and a head IC are mounted. The end of the extending part of the main FPC 38 is connected to the head actuator 14 and is connected to each magnetic head 33 via each relay FPC 35.

The VCM 16 has a supporting frame (not illustrated) extending from the bearing part 21 toward a direction opposite to the arms 27, and a voice coil supported by the supporting frame. In a state where the head actuator 14 is incorporated in the base 10a, the voice coil is positioned between a pair of yokes 34 fixed on the base 10a, and configures the VCM 16 with the yokes and a magnet fixed to the yokes.

By passing a current to the voice coil of the VCM 16 in a state where the magnetic disk 12 is rotating, the head actuator 14 revolves, and the magnetic head 33 is moved to and positioned on a desired track of the magnetic disk 12. In the embodiment described herein, the magnetic head 33 is moved along a radial direction of the magnetic disk 12 between an inner periphery edge part and an outer periphery edge part of the magnetic disk 12.

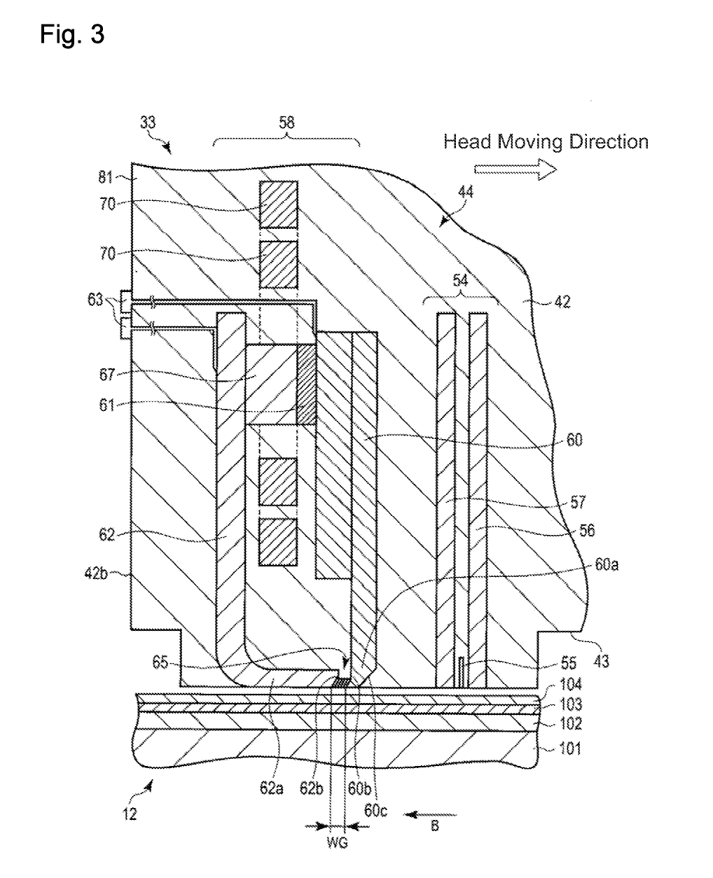

Next, detail descriptions of configurations of the magnetic disk 12 and the magnetic head 33 are given. FIG. 3 is an enlarged cross-sectional view of the head part 44 of the magnetic head 33 and the magnetic disk.

As illustrated in FIG. 1 through FIG. 3, the magnetic disk 12 has a substrate 101 that is for example formed in a disk shape having a diameter of about 2.5 inches and made of a nonmagnetic body. On each surface of the substrate 101, a soft magnetic layer 102 is laminated as an under layer made of a material having a soft magnetic property. On the soft magnetic layer 102, a magnetic recording layer 103 that has a magnetic anisotropy in a direction perpendicular to a disk surface is laminated. On the magnetic recording layer 103, a protective layer 104 is laminated.

As illustrated in FIG. 2 and FIG. 3, the magnetic head 33 is configured as a flying type head and has a slider 42 formed in a substantially cuboid shape and a head part 44 formed at an end part of the slider on the outflow end (trailing) side. The slider 42 is formed of, for example, a sintered compact of alumina and titanium carbide (ALTIC), and the head part 44 is formed by laminating a plurality of thin films.

The slider 42 has a rectangular-shaped air bearing surface (ABS) 43 facing the surface of the magnetic disk 12. The slider 42 flies due to an air flow C generated between the disk surface and the ABS 43 by rotation of the magnetic disk 12. The direction of the air flow C is identical to a rotation direction B of the magnetic disk 12. The slider 42 is arranged so that a longitudinal direction of the ABS 43 is substantially identical to the direction of the air flow C with respect to the surface of the magnetic disk 12.

The slider 42 has a leading end 42a positioned in an inflow side of the air flow C and a trailing end 42b positioned in the outflow side of the air flow C. On the ABS 43 of the slider 42, a leading step, a trailing step, a side step, a negative pressure cavity, and the like (not shown) are formed.

As illustrated in FIG. 3, the head part 44 has a reproducing head 54 and a recording head 58 formed at the trailing end 42b of the slider 42 in a thin film process, and is formed as a separate type magnetic head.

The reproducing head 54 is configured with a magnetic film 55 having a magneto-resistive effect, and shield films 56 and 57 arranged so as to sandwich the magnetic film 55 from a trailing side and a leading side of the magnetic film. Bottom ends of the magnetic film 55 and the shield films 56 and 57 are exposed to the ABS 43 of the slider 42.

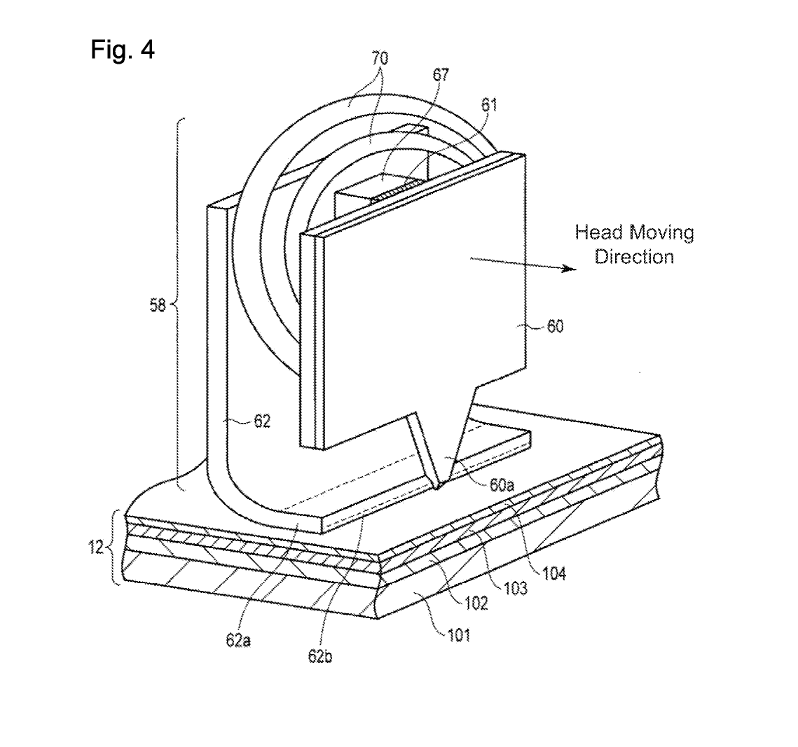

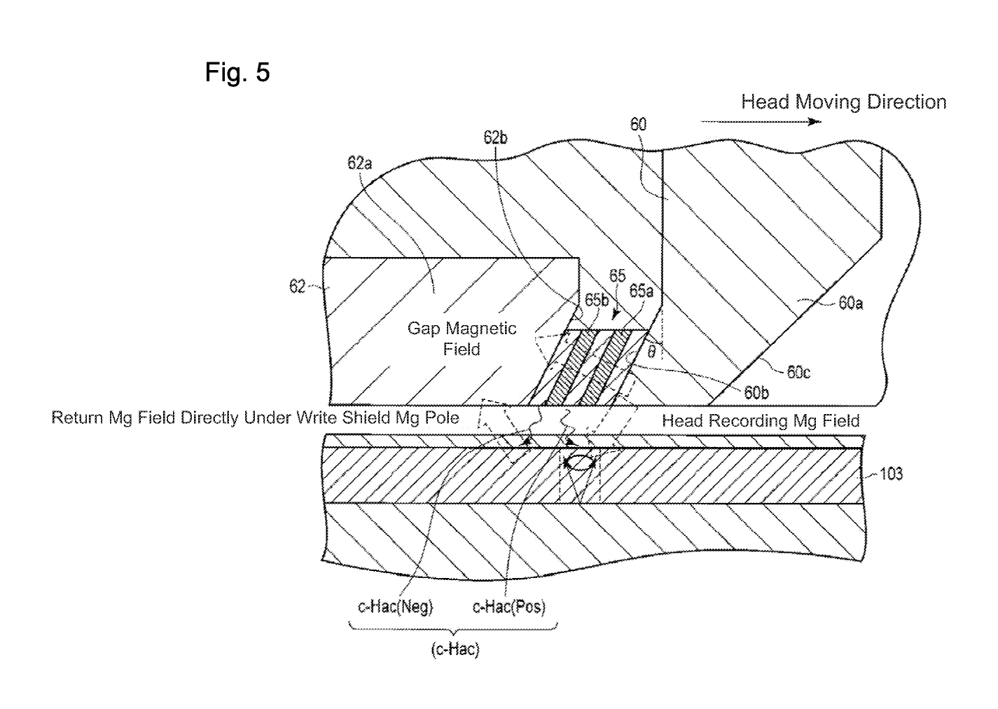

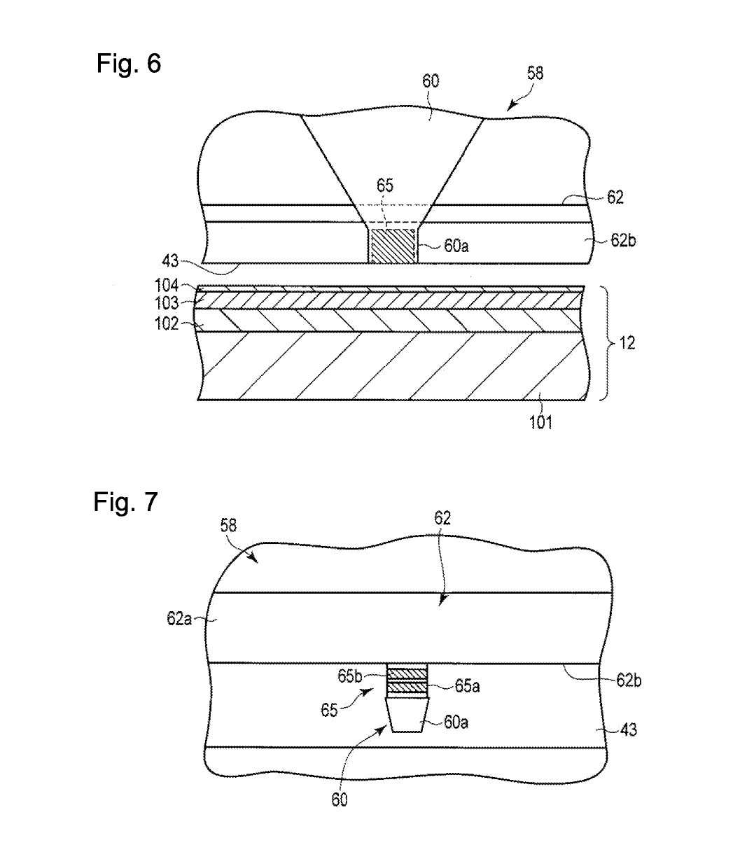

The recording head 58 is provided on the trailing end 42b side of the slider 42 with respect to the reproducing head 54. FIG. 4 is a perspective view schematically illustrating the recording head 58 and the magnetic disk 12. FIG. 5 is an enlarged cross-sectional view illustrating the tip part of the main magnetic pole and the tip part of the write shield magnetic pole of the recording head part. FIG. 6 is a side view of the ABS side end part of the recording head from the perspective of a leading end side of the slider. FIG. 7 is a plan view of the recording head portion from the perspective of the ABS side.

As illustrated in FIG. 3 and FIG. 4, the recording head 58 has a main magnetic pole 60, a write shield magnetic pole (trailing shield magnetic pole) 62, a junction part 67, a high frequency oscillator (for example, a spin torque oscillator 65), and a recording coil 70. The main magnetic pole 60 is formed of a soft magnetic material, and generates a recording magnetic field in a direction perpendicular to the surface of the magnetic disk 12 (to the recording layer). The soft magnetic material has a high permeability and a high saturation magnetic flux density. The write shield magnetic pole (trailing shield magnetic pole) 62 is formed of a soft magnetic material, and is arranged on the trailing side of the main magnetic pole 60 with a write gap WG interposed therebetween and is provided so as to efficiently close a magnetic path via the soft magnetic layer 102 directly under the main magnetic pole. The junction part 67 physically joins the upper part of the main magnetic pole 60 to the write shield magnetic pole 62. The high frequency oscillator (spin torque oscillator 65) is formed of a nonmagnetic conductive body arranged between the tip part 60a of the main magnetic pole 60 and the write shield magnetic pole 62 and on a portion of the ABS. The recording coil 70 is arranged wounding around a magnetic path including the main magnetic pole 60 and the write shield magnetic pole 62 to cause a magnetic flux to flow through the main magnetic pole 60 for writing signals to the magnetic disk 12. A current supplied to the recording coil 70 is controlled by the control circuit board 25 (control part) of the HDD.

An electrically insulating layer 61 is arranged on the junction part 67 of the main magnetic pole 60 and the write shield magnetic pole 62. Thereby, the main magnetic pole and the write shield magnetic pole are insulated each other. The main magnetic pole 60 and the write shield magnetic pole 62 are respectively electrically connected to drive terminal electrodes 63. A current circuit is configured such that a current is passed in series from these drive terminal electrodes 63 through the main magnetic pole 60, the spin torque oscillator 65, and the write shield magnetic pole 62. Thereby, the write shield magnetic pole 62 and the main magnetic pole 60 function as electrodes that perpendicularly pass a current to the spin torque oscillator 65.

The recording coil 70 is, for example, wound around the junction part 67 between the main magnetic pole 60 and the write shield magnetic pole 62. A current supplied from a power supply (not shown) to the recording coil 70 is controlled by the control circuit board 25 (control part) of the HDD. A predetermined current is supplied to the recording coil 70 from the power supply for writing signals to the magnetic disk 12, which causes a magnetic flux to flow to the main magnetic pole 60 and generates a magnetic field.

As illustrated in FIGS. 3, 4, 6 and 7, the main magnetic pole 60 extends substantially perpendicularly to the surface of the magnetic disk 12. The tip part 60a of the main magnetic pole 60 on the magnetic disk 12 side is tapered near the disk surface. The tip part 60a is in the form of a column having a narrower width than the other parts. A tip surface of the main magnetic pole 60 is exposed to the ABS 43 of the slider 42. The width of the tip part 60a in the track width direction is approximately equal to the width of a track of the magnetic disk 12.

The write shield magnetic pole 62 is formed substantially in an L-shape. A tip part 62a of the write shield magnetic pole 62 has an elongated rectangular shape. A tip surface of the write shield magnetic pole 62 is exposed to the ABS 43 of the slider 42. A leading side end surface 62b of the tip part 62a extends along the track width direction of the magnetic disk 12. This leading side end surface 62b faces the trailing side end surface 60b of the main magnetic pole 60 in parallel through the write gap WG interposed therebetween.

As illustrated in FIGS. 3 and 5, the spin torque oscillator 65 is provided in the write gap WG between the trailing side end surface 60b of the tip part 60a of the main magnetic pole 60 and the leading side end surface 62b of the tip part 62a of the write shield magnetic pole 62.

The spin torque oscillator 65 is configured by laminating an under layer, a spin injection layer (second magnetic body layer) 65a, an intermediate layer, an oscillation layer (first magnetic body layer) 65b, and a cap layer in this order from the main magnetic pole 60 side toward the trailing shield 62 side.

The trailing side end surface 60b of the tip part 60a of the main magnetic pole 60 is tilted toward a head leading side with respect to a direction that is perpendicular to the recording layer of the magnetic disk 12. That is, the trailing side end surface 60b has a tilt of angle θ towards the head leading side with respect to a direction perpendicular to the ABS 43.

The spin torque oscillator 65 faces the trailing side end surface 60b and is arranged so as to be in parallel with the trailing side end surface 60b. Thereby, the spin injection layer 65a, the oscillation layer 65b and the other layers of the spin torque oscillator 65 each have a tilt of an angle θ toward the head leading side with respect to the direction perpendicular to the ABS 43. Note that the end surface of the spin torque oscillator 65 on the ABS side is formed in parallel with and in the same plane as the ABS 43.

The write shield magnetic pole 62 has the leading side end surface 62b facing the spin torque oscillator 65. The leading side end surface 62b is tilted toward the head leading side with respect to the direction perpendicular to the recording layer of the magnetic disk 12. That is, the leading side end surface 62b has a tilt of an angle θ toward the head leading side with respect to the direction perpendicular to the ABS 43. Thereby, the leading side end surface 62b is positioned substantially in parallel with the spin torque oscillator 65.

In addition, in the present embodiment, the tip part 60a of the main magnetic pole 60 has a leading side end surface 60c that is positioned on an opposite side of the trailing side end surface 60b. The leading side end surface 60c is tilted toward the head leading side with respect to the direction perpendicular to the recording layer of the magnetic disk 12. That is, the leading side end surface 60c is tilted toward the head leading side with respect to the direction perpendicular to the ABS 43.

When the magnetic head is mounted in the magnetic disk device, in order to reduce a fringe magnetic field that deteriorates records of an adjacent track by adjusting a skew angle, a pole length is designed to have a length of 50 nm to 100 nm. The pole length is a length in a head moving direction on the ABS 43 of the main magnetic pole 60. In addition, to ensure a magnetic field intensity at which a recording state of the recording layer in the magnetic disk 12 is favorable, a thickness of the main magnetic pole 60 on the deep side (side extended away from the ABS in a height direction) is preferably increased. Accordingly, the main magnetic pole 60 is preferably configured so as to have a taper on the head leading side end surface 60c to narrow the thickness of the main magnetic pole toward the ABS 43.

As illustrated in FIG. 3, the reproducing head 54 and the recording head 58 are covered by a nonmagnetic protective insulation film 81 except for the portions exposed to the ABS 43. The protective insulation film 81 configures the outer shape of the head part 44.

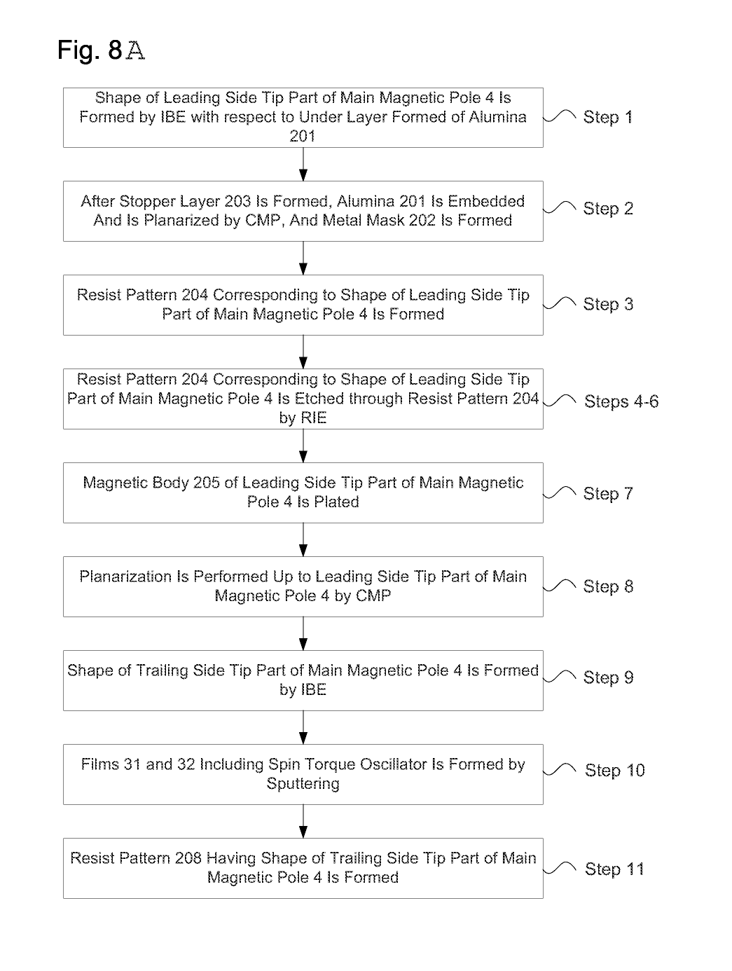

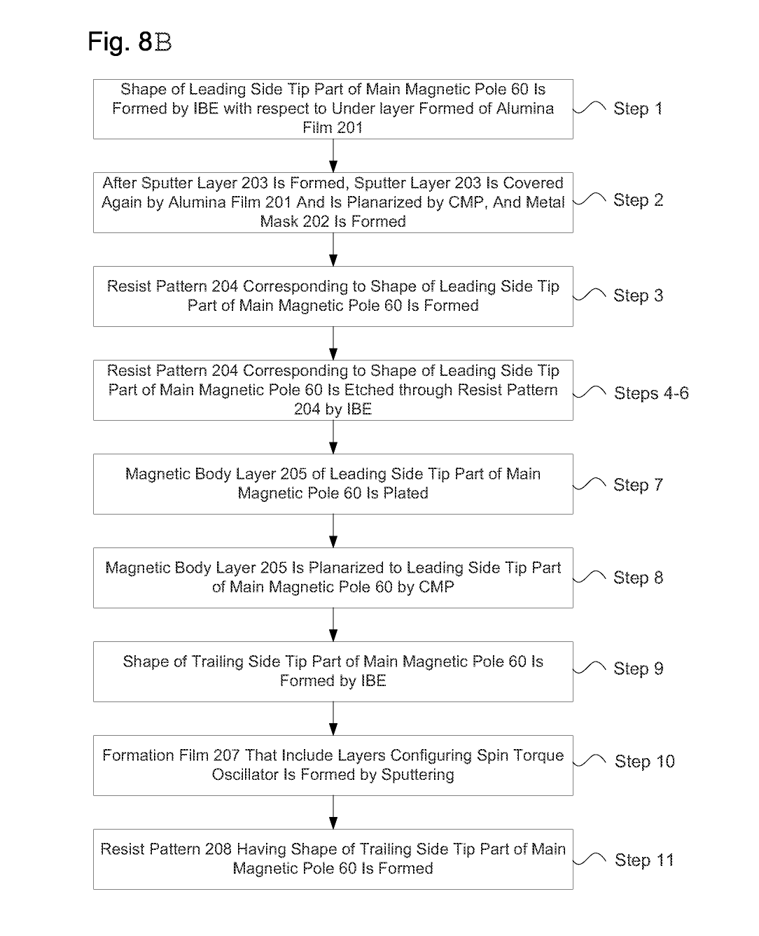

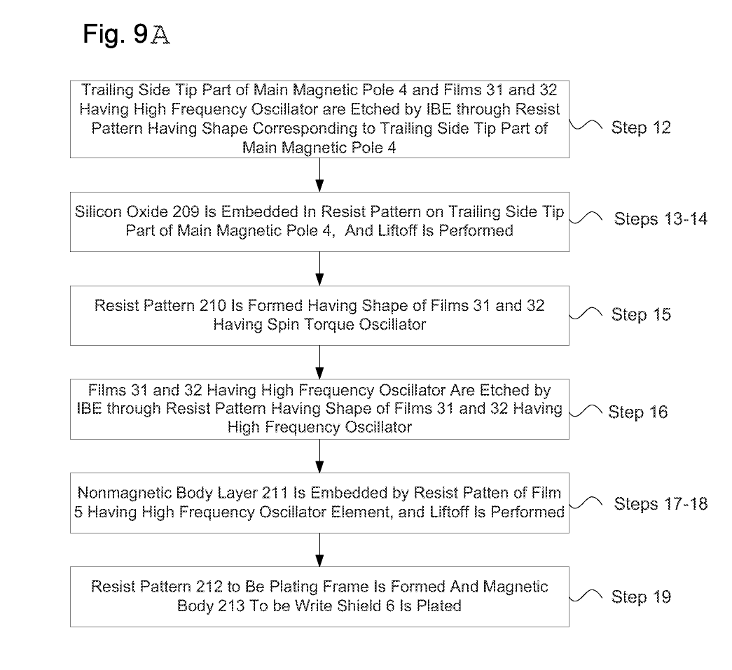

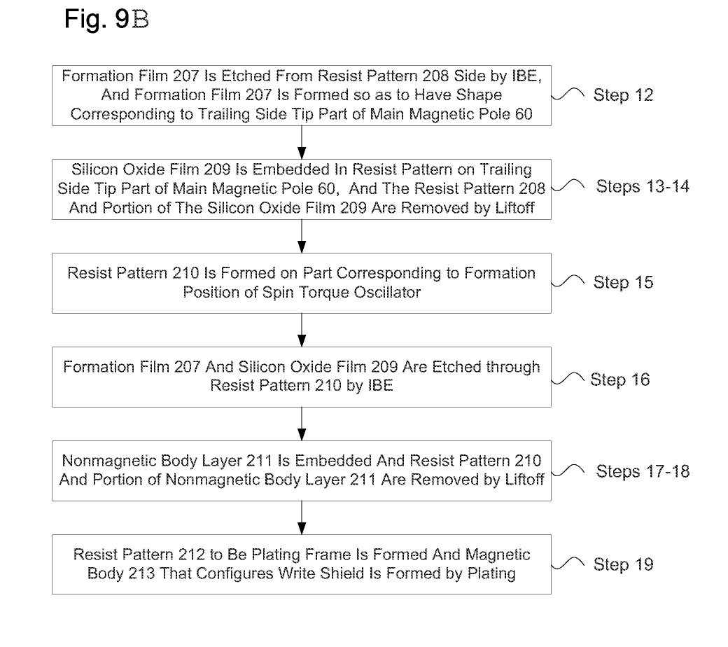

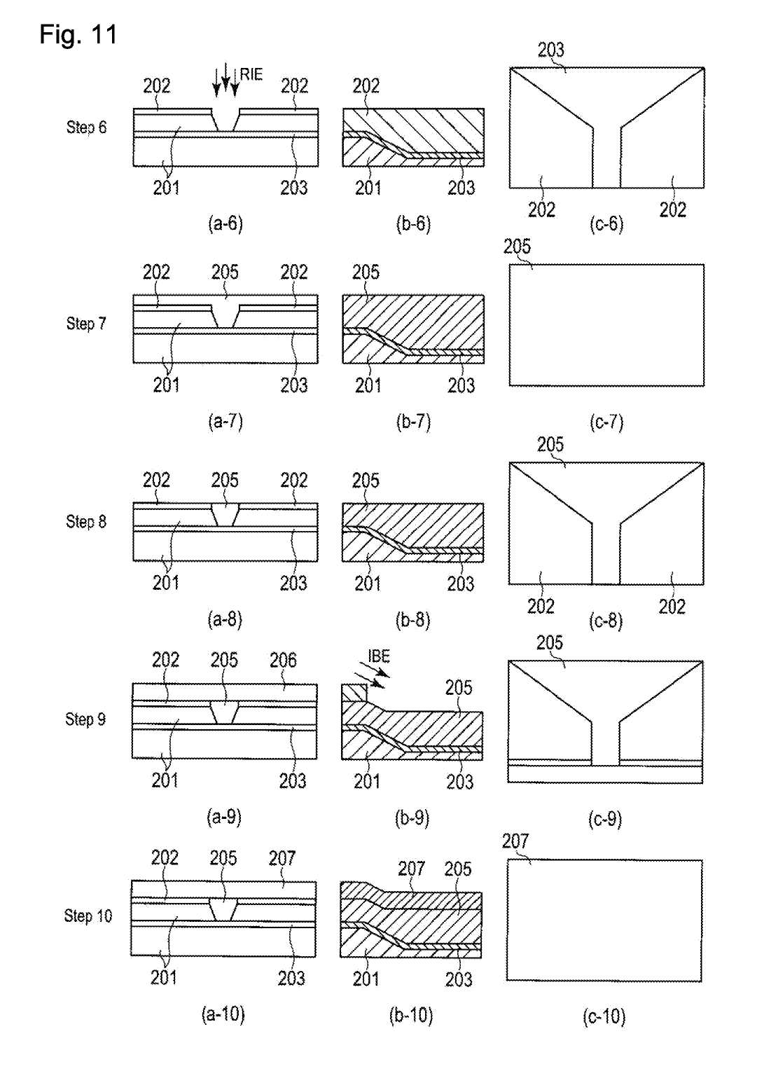

The manufacturing processes of the recording head 58 configured as described above will be explained. FIGS. 8A, 8B, 9A, and 9B are flowcharts illustrating the manufacturing process. FIGS. 11-13 are different views of the recording head from the perspective of the ABS side, vertical sectional views of the recording head and side views of the recording head from the perspective of the trailing side of steps at various steps of the manufacturing process of the recording head.

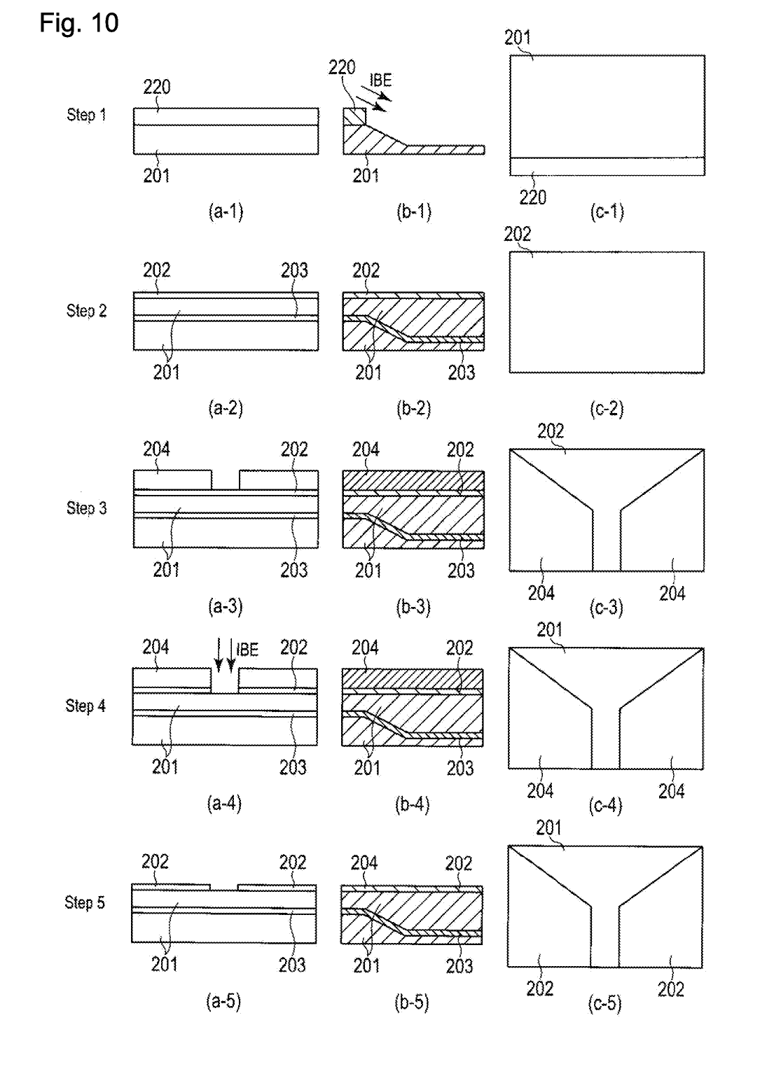

As described in FIG. 8A and illustrated in FIGS. 10 (a-1), (b-1), (c-1), an alumina film 201 is formed as an under layer, and a resist pattern 220 is formed thereon. In this state, the alumina film 201 is obliquely etched by ion beam etching (IBE), and thereby the shape of the leading side tip part of the main magnetic pole is formed (S1).

As illustrated in FIGS. 10 (a-2), (b-2), (c-2), after the resist pattern 220 is removed, a sputter layer 203 is formed on the alumina film 201. Furthermore, the upper side of the sputter layer 203 is covered again by the alumina film 201 and is planarized by chemical mechanical polishing (CMP). A metal mask 202 is formed on the alumina film 201 (S2).

As illustrated in FIGS. 10 (a-3), (b-3), (c-3), a resist pattern 204 that has a shape corresponding to the shape of the leading side tip part of the main magnetic pole 60 is formed on the metal mask 202 (S3). As illustrated in FIGS. 10 (a-4), (b-4), (c-4), the metal mask 202 is etched through the resist pattern 204 by IBE (S4). Then, as illustrated in FIGS. 10 (a-5), (b-5), (c-5), the resist pattern 204 is removed (S5).

As illustrated in FIGS. 11 (a-6), (b-6), (c-6), the shape of the leading side tip part of the main magnetic pole 60 is formed by etching the alumina film 201 through the metal mask 202 by reactive ion etching (RIE) (S6). Subsequently, as illustrated in FIGS. 11 (a-7), (b-7), (c-7), a magnetic body layer 205 is formed by plating on the leading side tip part region and the metal mask 202 (S7). Then, as illustrated in FIGS. 11 (a-8), (b-8), (c-8), the magnetic body layer 205 is planarized to the leading side tip part region by CMP (S8).

As illustrated in FIGS. 11 (a-9), (b-9), (c-9), a resist pattern 206 is formed on the ABS side end part of the magnetic body layer 205. In this state, the magnetic body layer 205 and the metal mask 202 are obliquely etched by IBE, and the shape of the trailing side tip part of the main magnetic pole 60 is formed (S9). Thereby, the main magnetic pole 60 that has an inclined trailing side end surface (relative to the ABS).

As illustrated in FIGS. 11 (a-10), (b-10), (c-10), a formation film 207 that includes a spin injection layer, an oscillation layer, an intermediate layer and a gap layer configuring the spin torque oscillator in that order, is formed on the magnetic body layer 205 and the metal mask 202 by sputtering (S10).

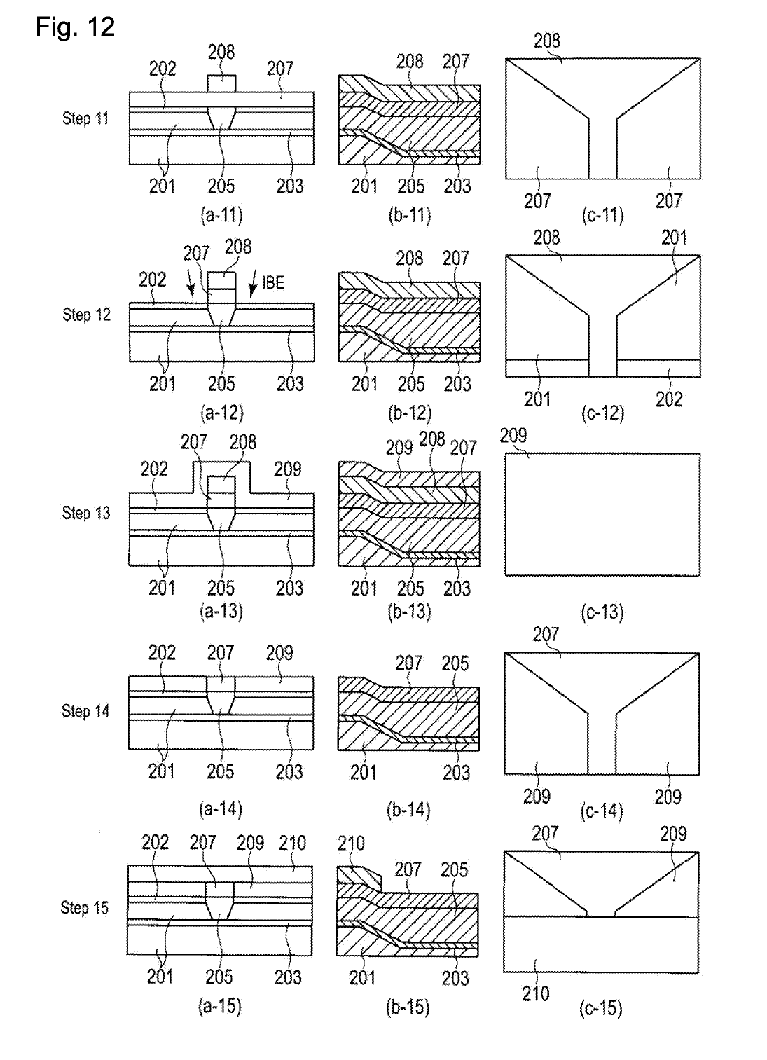

As illustrated in FIGS. 12 (a-11), (b-11), (c-11), a resist pattern 208 that has a shape corresponding to the shape of the trailing side tip part of the main magnetic pole 60 is formed on the formation film 207 (S11). Next, as described in FIG. 9A and illustrated in FIGS. 12 (a-12), (b-12), (c-12), the formation film 207 is etched from the resist pattern 208 side by IBE, and the formation film 207 is formed so as to have the shape corresponding to the trailing side tip part of the main magnetic pole 60 (S12).

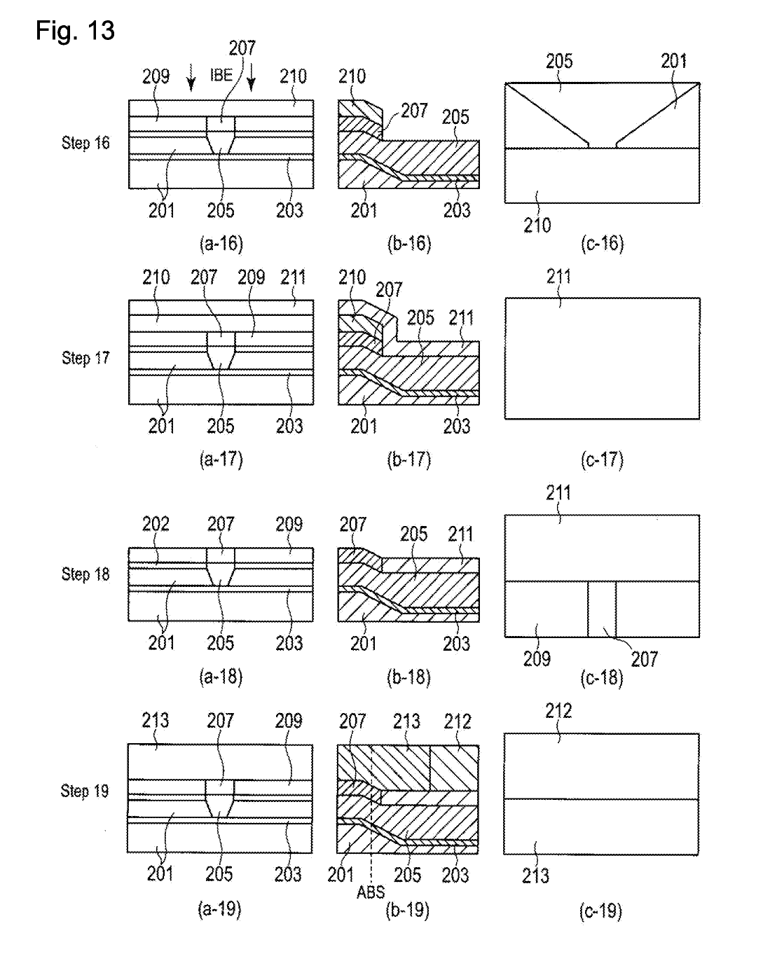

As illustrated in FIGS. 12 (a-13), (b-13), (c-13), an silicon oxide film 209 that covers the resist pattern 208 and the alumina film 201 is formed (S13). Then, as illustrated in FIGS. 12 (a-14), (b-14), (c-14), the resist pattern 208 and a portion of the silicon oxide film 209 formed thereon are removed by liftoff (S14).

Next, as illustrated in FIGS. 12 (a-15), (b-15), (c-15), a resist pattern 210 that has a width corresponding to the height of the spin torque oscillator is formed on a part corresponding to a formation position of the spin torque oscillator on the formation film 207 (S15). As illustrated in FIGS. 13 (a-16), (b-16), (c-16), the formation film 207 and the silicon oxide film 209 are etched through the resist pattern 210 by IBE to remove parts overlapping the upper part of the main magnetic pole 60 (S16).

As illustrated in FIGS. 13 (a-17), (b-17), (c-17), the resist pattern 210 is covered again by a nonmagnetic body layer 211 (S17). Next, as illustrated in FIGS. 13 (a-18), (b-18), (c-18), the resist pattern 210 and a portion of the nonmagnetic body layer 211 that is positioned on the resist pattern 210 are removed by liftoff (S 18).

Thereafter, as illustrated in FIGS. 13 (a-19), (b-19), (c-19), a resist pattern 212 to be a plating frame is formed and a magnetic body 213 that configures a write shield is formed by plating on the formation film 207 and the nonmagnetic body layer 211 (S19). Thereafter, the main magnetic pole, the spin torque oscillator and the write shield magnetic pole is planarized to the ABS by CMP. The main magnetic pole 60, the spin torque oscillator 65 and the write shield magnetic pole 62 that have the configurations mentioned above are formed in the steps mentioned above.

According to the HDD configured as described above, the head actuator 14 revolves by driving the VCM 16, and the magnetic head 33 is moved to and is positioned on an intended track of the magnetic disk 12. Moreover, the magnetic head 33 flies by the air flow C generated between the disk surface and the ABS 43 by the rotation of the magnetic disk 12. During the operation of the HDD, the ABS 43 of the slider 42 faces the disk surface maintaining a gap therebetween. As illustrated in FIG. 2, the magnetic head 33 flies in an inclined orientation such that a recording head 58 portion of the head part 44 most closely approaches the surface of the magnetic disk 12. In such a state, reading of recorded information from the magnetic disk 12 is performed by the reproducing head 54, and writing of information to the magnetic disk 12 is performed by the recording head 58.

During writing of information, the main magnetic pole 60 is excited by the recording coil 70, and a recording magnetic field in a perpendicular direction is applied from the main magnetic pole to the recording layer 103 of the magnetic disk 12 positioned directly under the main magnetic pole. Therefore, information is recorded in the recording layer 103 at a desired track.

At this time, as illustrated in FIG. 5, when a current is passed between the main magnetic pole 60 and the write shield magnetic pole 62 in a perpendicular direction with respect to a film surface of the spin torque oscillator 65 and is passed through the recording coil 70, a high-frequency magnetic field c-Hac is generated as a leakage magnetic field from the spin torque oscillator 65 by the uniform magnetization rotation of the magnetization in the spin torque oscillator 65 due to a gap magnetic field generated between the main magnetic pole 60 and the write shield magnetic pole 62. Due to the direction of the rotation magnetization generated in the spin torque oscillator, the rotation direction of a high-frequency magnetic field c-Hac generated on the surface facing the main magnetic pole 60 (trailing side end surface 60b) and the rotation direction of a high-frequency magnetic field c-Hac generated on the surface facing the write shield magnetic pole 62 (leading side end surface 62b) are opposite to each other. Due to the rotation directions of the high-frequency magnetic fields c-Hac, the high-frequency magnetic field c-Hac (Pos) generated on the main magnetic pole 60 side works to favor a magnetization reversal state of the recording layer 103 by the magnetic field from the main magnetic pole 60. On the other hand, the high-frequency magnetic field c-Hac (Neg) generated on the write shield magnetic pole 62 side works to increase a return field partial erasure (RFPE) that deteriorates information on the recording layer 103 by a return magnetic field directly under the write shield magnetic pole.

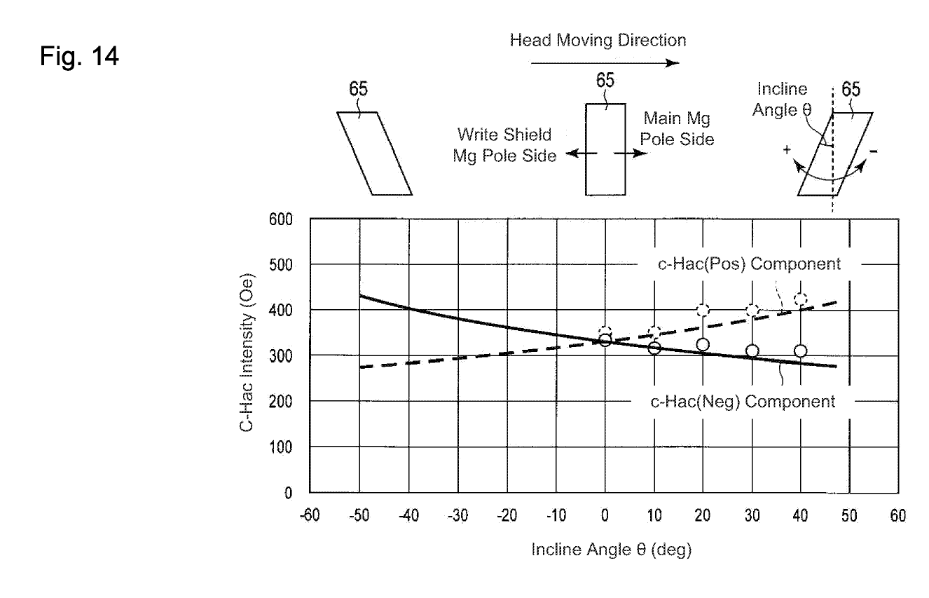

FIG. 14 illustrates results of the examination of the intensity of high-frequency magnetic field c-Hac examined by calculating the dependency of the tilt angle θ of the spin torque oscillator 65. Here, the tilt angle θ>0 between the trailing side end surface 60b of the main magnetic pole 60 and the spin torque oscillator 65 represents an arrangement where the spin torque oscillator 65 tilts toward the head leading side as viewed from the ABS 43 toward the deep side of the height direction (direction extending away from the ABS), and the tilt angle θ<0 represents an arrangement where the spin torque oscillator 65 tilts toward the head leading side as viewed from the ABS 43 toward the deep side of the height direction.

An intensity of each component of the high-frequency magnetic field c-Hac that generated from the spin torque oscillator 65 was calculated and plotted on the FIG. 14. In the FIG. 14, the property line illustrated with a dotted line indicates the intensity of the high-frequency magnetic field c-Hac (Pos) at a position of 10 nm (corresponding to the recording layer intermediate part) from the ABS 43 toward recording layer 103 and the property line illustrated with a solid line indicates the intensity of the high-frequency magnetic field c-Hac (Neg). The lines respectively indicate the intensity corresponding to the tilt angle θ. As will be noted from the property lines, the high-frequency magnetic field c-Hac on the side toward which the spin torque oscillator 65 tilts increases. It should be understood that it becomes possible to increase the high-frequency magnetic field c-Hac (Pos) and decrease the high-frequency magnetic field c-Hac (Neg) by inclining the spin torque oscillator 65 toward the head leading side. In the present embodiment, the tilt angle θ of the trailing side end surface 60b of the main magnetic pole 60 and the spin torque oscillator 65 is set to be 0<θ≦45° and is preferably set to be approximately 15°<θ<40°.

As mentioned above, the high-frequency magnetic field c-Hac (Pos) that generated from the spin torque oscillator 65 increases as the high-frequency magnetic field c-Hac (Neg) generated from the spin torque oscillator 65 decreases. Thereby, the quality of signals that are recorded in a recording medium is improved. As a result, an increase in recording density is realized.

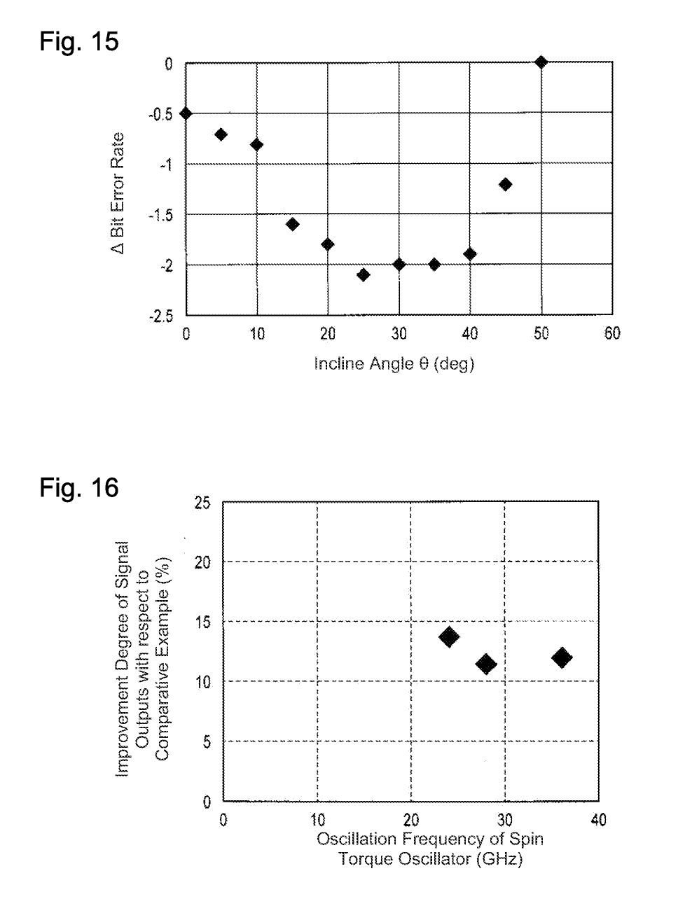

FIG. 15 illustrates the relationship between the bit error rate of the recording head and the tilt angle θ of the trailing shield side end surface of the main magnetic pole. The A bit error rate on the vertical axis indicates the difference between the bit error rate of a case where a recording head without the spin torque oscillator is used and the bit error rate of a case where a recording head with the spin torque oscillator is used. In a case where the tilt angle θ=0°, the improvement of approximately −0.5 digit with respect to the bit error rate of the case where the recording head without the spin torque oscillator is only observed by RFPE assist. However, it will be understood that the contribution of the RFPE assist decreases by increasing the tilt angle θ, that is, the high-frequency magnetic field c-Hac (Neg) decreases, and the bit error rate is improved by—two digits within a range of the tilt angle θ=20 through 40°.

It has been understood that a gap magnetic field of approximately 7800 (Oe) is needed in order to cause the spin torque oscillator 65 to oscillate. The main magnetic pole 60 needs to be parallel with the spin torque oscillator 65 to ensure the intensity of the gap magnetic field. It will be understood that in the first embodiment discussed above, in a case of the tilt angle θ>45°, the spin torque oscillator does not oscillate when the intensity of the gap magnetic field is lower than the intensity necessary to oscillate, so that the bit error rate is not improved.

The results mentioned above indicate that when the tilt angles θ of the trailing side end surface of the main magnetic pole 60 and the spin torque oscillator are within the range of 0<θ≦45°, the high-frequency magnetic field c-Hac (Pos) increases as the high-frequency magnetic field c-Hac (Neg) decreases with the gap magnetic field maintained. Thereby, the deterioration of the information of the recording layer 103 is suppressed and the quality of signals that are recorded to a recording medium is improved. As a result, the increase in the recording density is realized.

FIG. 16 illustrates a comparison between the performance of the magnetic head according to the present embodiment and the performance of a magnetic head according to a comparative example in which an tilt angle θ of a spin torque oscillator is θ=0°. Note that, in the magnetic head according to the present embodiment, the angle (tilt angle θ) between the trailing side end surface 60b of the main magnetic pole 60 facing the spin torque oscillator 65 and the film growth surface (in a direction perpendicular to the ABS 43) is 25°, the length of the write gap between the main magnetic pole 60 and the write shield magnetic pole 62 40 nm, and the length of the main magnetic pole on the ABS 43 in the track width direction 50 nm. The anisotropy field Hk of the recording layer 103 that performs recording is 16 kOe.

The spin torque oscillator 65 was oscillated at the oscillation frequencies of 24 GHz, 28 GHz, and 36 GHz, and signal outputs of respective recording patterns for the oscillation frequencies when the writing to the magnetic disk was performed were calculated. An increase (%) of signal output for the case where the spin torque oscillator 65 oscillates with respect to the case where the spin torque oscillator 65 does not oscillate was set as an assist gain. The difference between the assist gain of the magnetic head according to the present embodiment and the assist gain of the magnetic head according to the comparative example was defined as an assist improvement degree (%). The assist improvement degrees of a plurality of oscillation frequencies were plotted. The improvement of the assist gain of 10 through 15% is indicated in the magnetic head according to the present embodiment with respect to the magnetic head according to the comparative example in the region of the oscillation frequencies mentioned above.

In the recording head of the HDD according to the present embodiment, the deterioration of the record signals is suppressed due to the decrease in the high-frequency magnetic field c-Hac (Neg). Thereby, the quality of signals that are recorded to a recording medium is improved. As a result, the recording head and the HDD including the recording head that can achieve an increase in the recording density are obtained.

Next, descriptions regarding HDDs and magnetic heads according to other embodiments are given. Note, in the following description of the various embodiments, the same reference numbers are given to portions that are the same as the corresponding portions of the above-described first embodiment and its detailed descriptions are omitted.

### Second Embodiment

Next, descriptions regarding a recording head of an HDD according to a second embodiment are given.

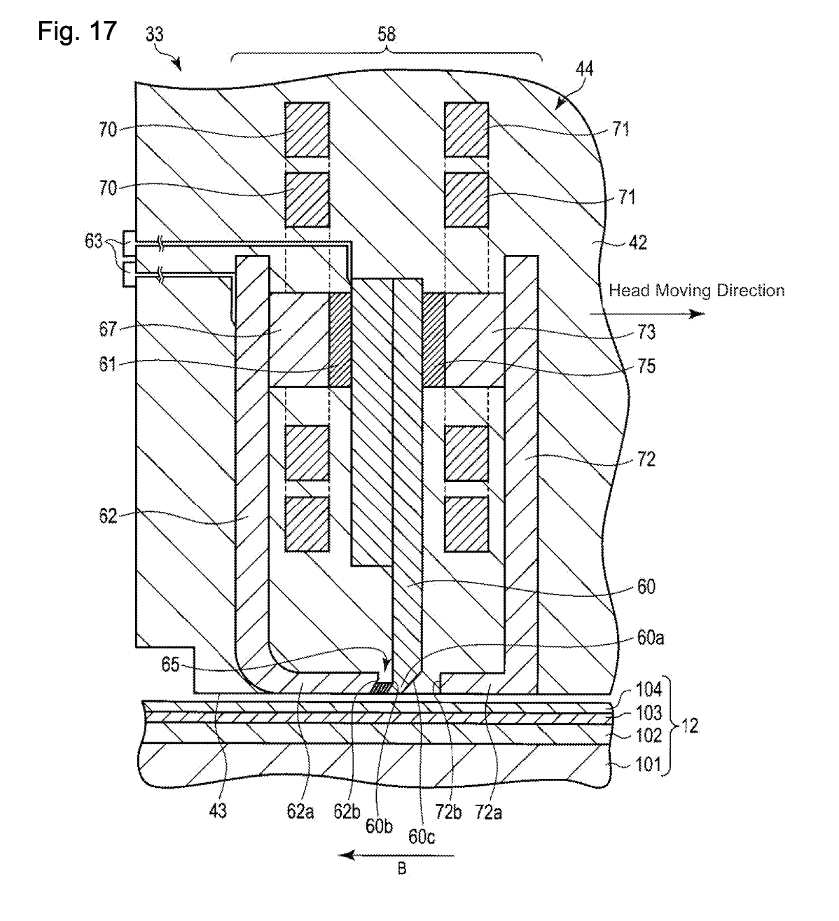

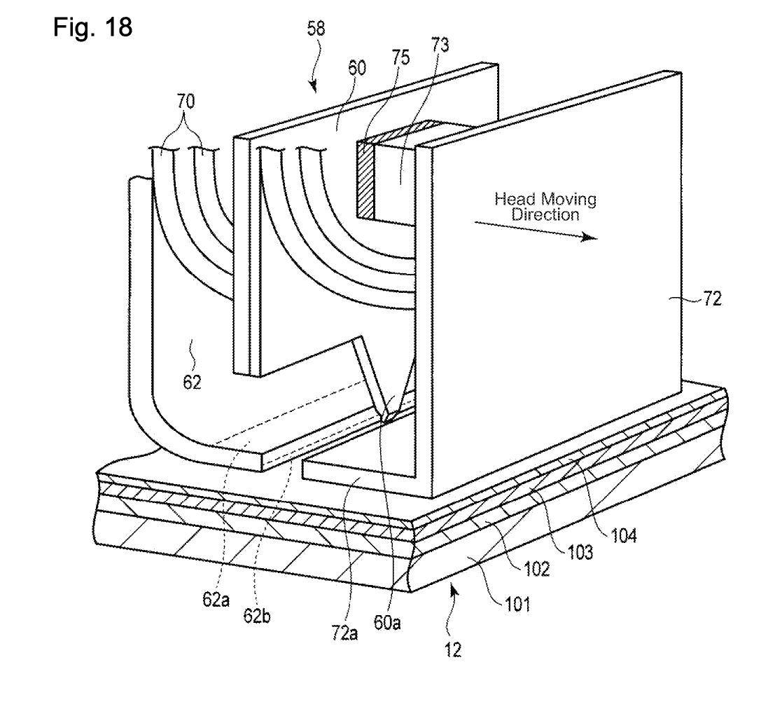

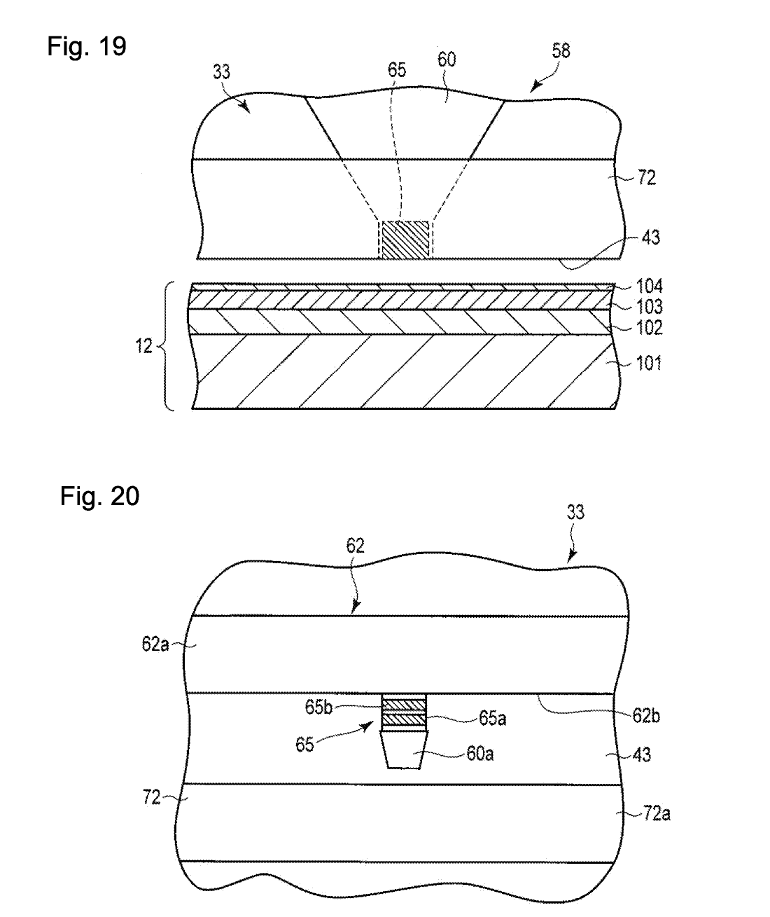

FIG. 17 is an enlarged cross-sectional view illustrating a recording head, especially a recording head part of the magnetic head of the HDD according to the second embodiment. FIG. 18 is a perspective view schematically illustrating the recording head. FIG. 19 is a side view of the ABS side end part of the recording head from the perspective of the leading end side of the slider. FIG. 20 is a plan view of the recording head from the perspective of the ABS side.

A configuration of a recording head 58 of the HDD according to the second embodiment is mainly different from that of the recording head according to the first embodiment in that the recording head 58 according to the second embodiment further includes a leading shield magnetic pole. Other configurations thereof are the same as those of the recording head according to the first embodiment. The same reference numbers are given to portions that are the same in the first embodiment and their detailed descriptions are omitted.

As illustrated in FIG. 17 through FIG. 20, according to the second embodiment, the recording head 58 of the HDD has the main magnetic pole 60, the write shield magnetic pole (trailing shield magnetic pole) 62, the junction part 67, the high frequency oscillator (for example, the spin torque oscillator 65), and the recording coil 70. The main magnetic pole 60 is formed of a soft magnetic material, and generates a recording magnetic field in a direction perpendicular to the surface of the magnetic disk 12 (to the recording layer). The soft magnetic material has a high permeability and a high saturation magnetic flux density. The write shield magnetic pole (trailing shield magnetic pole) 62 is formed of a soft magnetic material, and is arranged on the trailing side of the main magnetic pole 60 with a write gap WG interposed therebetween and is provided so as to efficiently close a magnetic path via the soft magnetic layer 102 directly under the main magnetic pole. The junction part 67 joins the upper part of the main magnetic pole 60 to the write shield magnetic pole 62. The high frequency oscillator (spin torque oscillator 65) is formed of a nonmagnetic conductive body arranged between the tip part 60a of the main magnetic pole 60 and the write shield magnetic pole 62 and on a portion of the ABS. The recording coil 70 is wound around a magnetic path including the main magnetic pole 60 and the write shield magnetic pole 62 to cause a magnetic flux to flow through the main magnetic pole 60 for writing signals to the magnetic disk 12. The recording head 58 further has a leading shield magnetic pole 72 and a recording coil 71. The leading shield magnetic pole 72 is arranged on the leading side of the main magnetic pole 60 and is provided so as to efficiently close a magnetic path via a soft magnetic layer directly under the main magnetic pole. The recording coil 71 is wound around a magnetic path including the main magnetic pole and the leading shield magnetic pole to cause a magnetic flux to flow through the main magnetic pole 60.

The spin torque oscillator 65 is arranged between the tip part of the main magnetic pole 60 and the tip part of the write shield magnetic pole 62. These are configured in the same manner as in the first embodiment discussed above.

The leading shield magnetic pole 72 is formed substantially in an L-shape. A tip part 72a of the leading shield magnetic pole 72 has an elongated rectangular shape. A tip surface of the leading shield magnetic pole 72 is exposed to the ABS 43 of the slider 42. A trailing side end surface 72b of the tip part 72a faces the leading side end surface 60c of the main magnetic pole 60 through a gap interposed therebetween.

Electrically insulating layers 61 and 75 are respectively arranged on the junction part 67 between the main magnetic pole 60 and the write shield magnetic pole 62 and on the junction part 73 between the main magnetic pole 60 and the leading shield magnetic pole 72. Thereby, the main magnetic pole 60 and the write shield magnetic pole 62, and the main magnetic pole 60 and the leading shield magnetic pole 72 are respectively insulated from each other. Parts of the main magnetic pole 60 and the write shield magnetic pole 62 are respectively electrically connected to the drive terminal electrodes 63.

In the second embodiment configured as mentioned above, the deterioration of the recording signals is suppressed due to a decrease in the high-frequency magnetic field c-Hac (Neg). Thereby, the quality of signals that are recorded to a recording medium is improved. As a result, the recording head and the HDD including the recording head that can achieve an increase in the recording density are obtained.

### Third Embodiment

Next, descriptions regarding a recording head of an HDD according to a third embodiment are given.

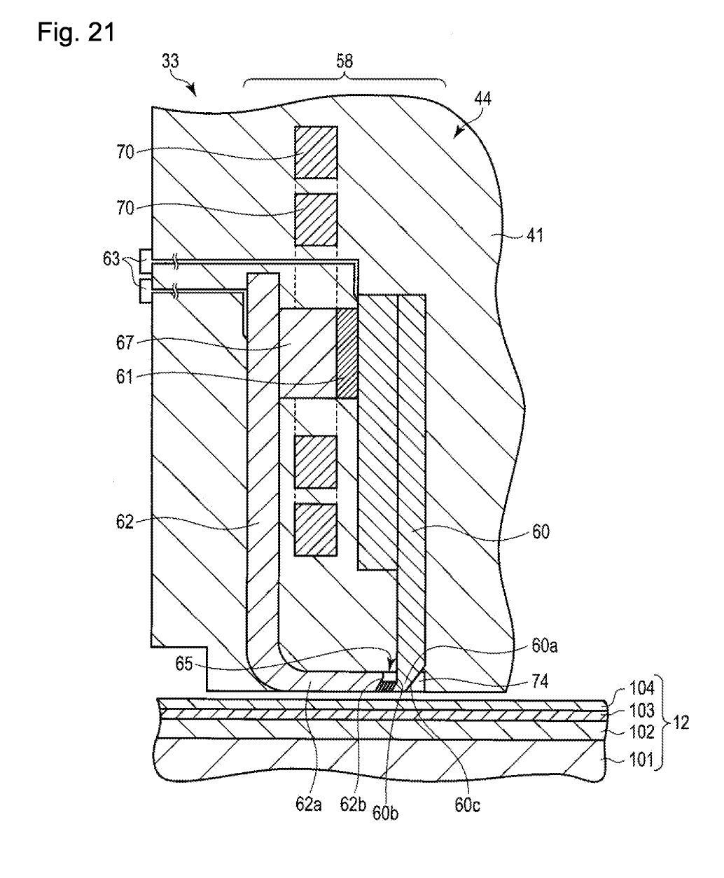

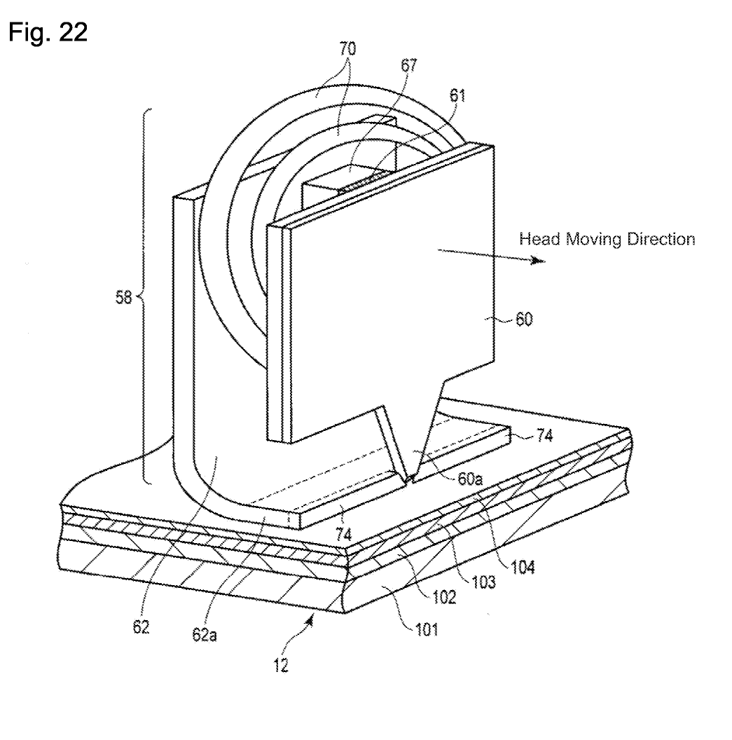

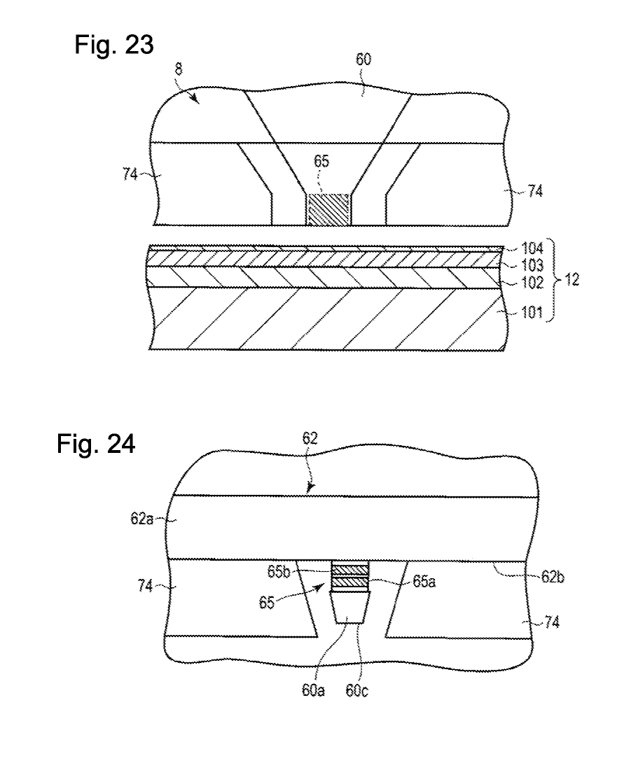

FIG. 21 is an enlarged cross-sectional view illustrating a recording head, especially a head part of a magnetic head of the HDD according to the third embodiment. FIG. 22 is a perspective view schematically illustrating the recording head. FIG. 23 is a side view of the ABS side end part of the recording head from the perspective of the leading end side of the slider. FIG. 24 is a plan view of the recording head from the perspective of the ABS side.

A configuration of the recording head 58 of the HDD according to the third embodiment is mainly different from that of the recording head according to the first embodiment in that the recording head 58 according to the third embodiment includes a side shield. Other configurations thereof are the same as those of the recording head according to the first embodiment. The same reference numbers are given to portions that are the same in the first embodiment and their detailed descriptions are omitted.

As illustrated in FIG. 21 through FIG. 24, according to the third embodiment, the recording head 58 of the HDD has the main magnetic pole 60, the write shield magnetic pole (trailing shield magnetic pole) 62, the junction part 67, the high frequency oscillator (for example, the spin torque oscillator 65), and the recording coil 70. The main magnetic pole 60 is formed of a soft magnetic material, and generates a recording magnetic field in a direction perpendicular to the surface of the magnetic disk 12 (to the recording layer). The soft magnetic material has a high permeability and a high saturation magnetic flux density. The write shield magnetic pole (trailing shield magnetic pole) 62 is formed of a soft magnetic material, and is arranged on the trailing side of the main magnetic pole 60 with a write gap WG interposed therebetween and is provided so as to efficiently close a magnetic path via the soft magnetic layer 102 directly under the main magnetic pole. The junction part 67 joins the upper part of the main magnetic pole 60 to the write shield magnetic pole 62. The high frequency oscillator (spin torque oscillator 65) is formed of a nonmagnetic conductive body arranged between the tip part 60a of the main magnetic pole 60 and the write shield magnetic pole 62 and on a portion of the ABS. The recording coil 70 is wound around a magnetic path including the main magnetic pole 60 and the write shield magnetic pole 62 to cause a magnetic flux to flow through the main magnetic pole 60 for writing signals to the magnetic disk 12. The recording head 58 further has a pair of side shields 74. The side shields 74 are formed of a soft magnetic material and are arranged on both sides of the main magnetic pole 60 in the track width direction so as to be magnetically separated from the main magnetic pole 60 on the ABS 43.

The pair of side shields 74 is formed of a high permeability material and is formed in an integrated manner with the tip part 62a of the write shield magnetic pole 62. The side shields 74 projects from the leading side end surface 62b of the tip part 62a toward the leading end side of the slider 42. Each side shield 74 extends from the leading side end surface of the write shield magnetic pole 62 to a level position, passing across the leading side end surface 60c of the main magnetic pole 60.

The spin torque oscillator 65 is arranged between the tip part of the main magnetic pole 60 and the tip part of the write shield magnetic pole 62. These are configured in the same manner as the first embodiment discussed above.

In the third embodiment configured as mentioned above, the deterioration of the recording signals is suppressed due to an decrease in the high-frequency magnetic field c-Hac (Neg). Thereby, the quality of signals that are recorded to a recording medium is improved. As a result, the recording head and the disk device including the recording head that can achieve an increase in the recording density are obtained.

### Fourth Embodiment

Next, descriptions regarding a recording head of an HDD according to a fourth embodiment are given.

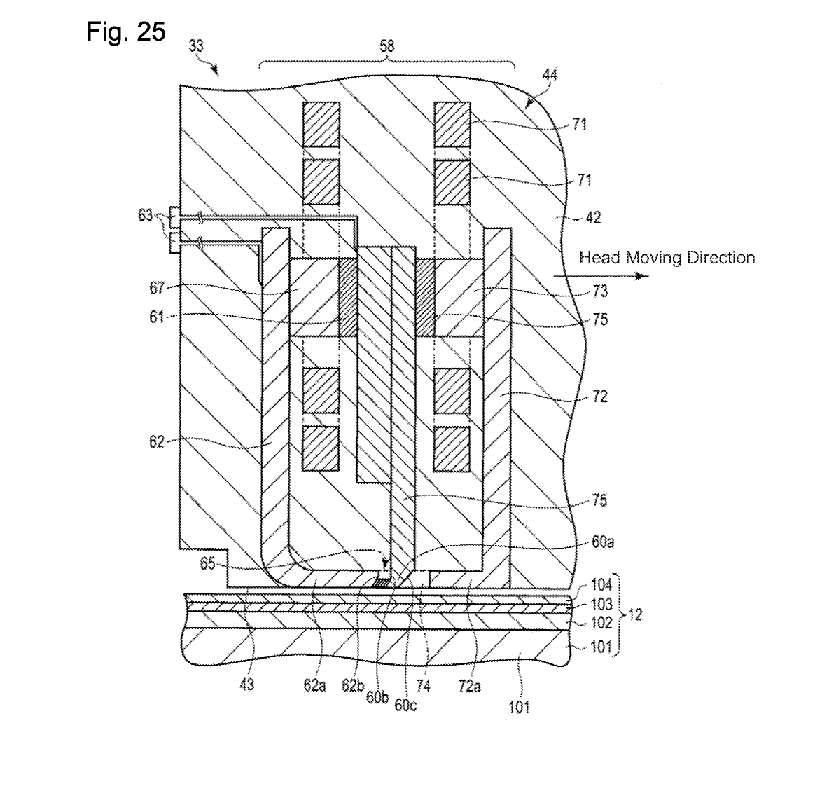

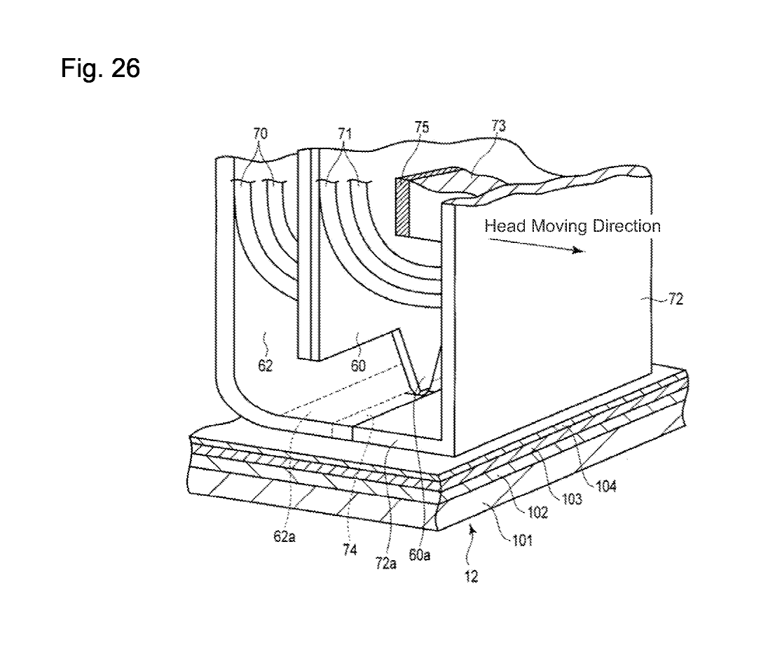

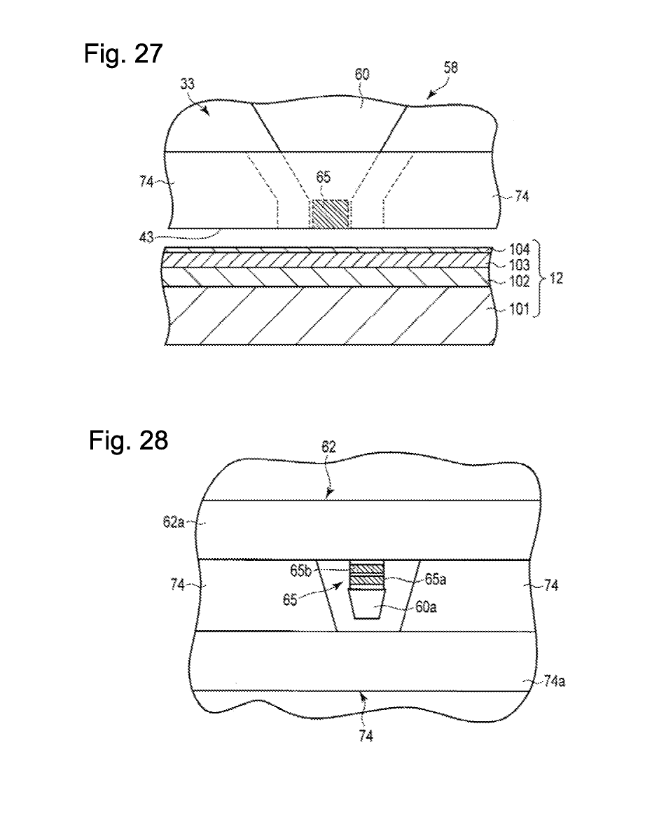

FIG. 25 is an enlarged cross-sectional view illustrating a recording head, especially a head part of a magnetic head of the HDD according to the fourth embodiment. FIG. 26 is a perspective view schematically illustrating the recording head. FIG. 27 is a side view of the ABS side end part of the recording head from the perspective of the leading end side of the slider. FIG. 28 is a plan view of the recording head from the perspective of the ABS side.

A configuration of the recording head 58 of the HDD according to the fourth embodiment is mainly different from that of the recording head according to the first embodiment in that the recording head 58 according to the fourth embodiment includes a leading shield magnetic pole and side shields. Other configurations thereof are the same as those of the recording head according to the first embodiment. The same reference numbers as those according to the first embodiment are given to portions the same as the corresponding portions of the above-described first embodiment and its detailed descriptions are omitted.

As illustrated in FIG. 25 thought FIG. 28, according to the fourth embodiment, the recording head 58 of the HDD has the main magnetic pole 60, the write shield magnetic pole (trailing shield magnetic pole) 62, the junction part 67, the high frequency oscillator (for example, the spin torque oscillator 65), and the recording coil 70. The main magnetic pole 60 is formed of a soft magnetic material, and generates a recording magnetic field in a direction perpendicular to the surface of the magnetic disk 12 (to the recording layer). The soft magnetic material has a high permeability and a high saturation magnetic flux density. The write shield magnetic pole (trailing shield magnetic pole) 62 is formed of a soft magnetic material, and is arranged on the trailing side of the main magnetic pole 60 with a write gap WG interposed therebetween and is provided so as to efficiently close a magnetic path via the soft magnetic layer 102 directly under the main magnetic pole. The junction part 67 joins the upper part of the main magnetic pole 60 to the write shield magnetic pole 62. The high frequency oscillator (spin torque oscillator 65) is formed of a nonmagnetic conductive body arranged between the tip part 60a of the main magnetic pole 60 and the write shield magnetic pole 62 and on a portion of the ABS. The recording coil 70 is wound around a magnetic path including the main magnetic pole 60 and the write shield magnetic pole 62 to cause a magnetic flux to flow through the main magnetic pole 60 for writing signals to the magnetic disk 12. The recording head 58 further has the leading shield magnetic pole 72, the recording coil 71 and the pair of side shields 74. The leading shield magnetic pole 72 is arranged on the leading side of the main magnetic pole 60 and is provided so as to efficiently close a magnetic path via the soft magnetic layer directly under the main magnetic pole. The recording coil 71 is wound around a magnetic path including the main magnetic pole and the leading shield magnetic pole to cause a magnetic flux to flow through the main magnetic pole 60. The side shields 74 are formed of the soft magnetic material, and are arranged on both sides in the track width direction of the main magnetic pole 60 so as to be magnetically separated from the main magnetic pole 60 on the ABS 43.

The pair of side shields 74 is formed of a high permeability material, and is formed in an integrated manner with the tip part 62a of the write shield magnetic pole 62. The side shields 74 projects from the leading side end surface 62b of the tip part 62a toward the leading end side of the slider 42. Each side shield 74 extends from the leading side end surface of the write shield magnetic pole 62 to a level position, passing across the leading side end surface 60c of the main magnetic pole 60.

The leading shield magnetic pole 72 is formed substantially in an L-shape. The tip part 72a of the leading shield magnetic pole has an elongated rectangular shape. A tip surface of the leading shield magnetic pole 72 is exposed to the ABS 43 of the slider 42. A trailing side end surface 72b of the tip part 72a faces the leading side end surface 60c of the main magnetic pole 60 through a gap interposed therebetween. In addition, the trailing side end surface 72b joins the tip surfaces of the side shields 74. In the present embodiment, the leading shield magnetic pole 72 is formed of the soft magnetic material, and is formed in an integrated manner with the write shield magnetic pole 62 and the side shields 74.

Electrically insulating layers 61 and 75 are respectively arranged on the junction part 67 between the main magnetic pole 60 and the write shield magnetic pole 62 and on the junction part 73 between the main magnetic pole 60 and the leading shield magnetic pole 72. Thereby, the main magnetic pole 60 and the write shield magnetic pole 62, and the main magnetic pole 60 and the leading shield magnetic pole 72 are respectively insulated from each other. Parts of the main magnetic pole 60 and the write shield magnetic pole 62 are respectively electrically connected to the drive terminal electrodes 63.

The spin torque oscillator 65 is arranged between the tip part of the main magnetic pole 60 and the tip part of the write shield magnetic pole 62. These are configured in the same manner as the first embodiment discussed above.

In the fourth embodiment configured as mentioned above, the deterioration of the recording signals is suppressed due to a decrease in the high-frequency magnetic field c-Hac (Neg). Thereby, the quality of signals that are recorded to a recording medium is improved. As a result, the recording head and the disk device including the recording head that can achieve an increase in the recording density are obtained.

These embodiments that have been described are not intended to limit the scope of the inventions to the way of presented example only. Indeed, the novel embodiments described herein may be embodied by modifying components without departing from the spirit of the inventions. An arbitral combination of plural components disclosed in the above-described embodiments may form various inventions. For example, some components may be eliminated from all of the components described in the embodiments. Furthermore, components according to different embodiments may be arbitrarily combined.

For example, it is possible to change the material, shape, size, and the like of elements configuring the head part as necessary. Also, it is possible to increase the number of magnetic disk and magnetic head in the magnetic disk device as necessary, and the size of magnetic disk may vary.

We claim:

1. A recording head, comprising:
a main magnetic pole that generates a recording magnetic field in a direction perpendicular to a recording layer of a recording medium;
a write shield magnetic pole disposed on a trailing side of the main magnetic pole with a write gap interposed therebetween; and
a spin torque oscillator that is provided in the write gap between the main magnetic pole and the write shield magnetic pole and generates a high frequency magnetic field, wherein
the main magnetic pole includes a trailing side end surface that faces the spin torque oscillator and extends so as to be tilted toward a leading side of the recording head with respect to the direction perpendicular to the recording layer of the recording medium, and
the spin torque oscillator has one or more layers and the layers have tilted surfaces that are substantially in parallel with the trailing side end surface.

2. The recording head according to claim 1, wherein the write shield magnetic pole has a leading side end surface that faces the spin torque oscillator and extends so as to be tilted toward the leading side of the recording head with respect to the direction perpendicular to the recording layer of the recording medium to be substantially in parallel with the surfaces of the layers of the spin torque oscillator.

3. The recording head according to claim 2, wherein the main magnetic pole has a leading side end surface that is positioned on a side of the main magnetic pole that is opposite to the trailing side end surface and tilts toward the leading side of the recording head with respect to the direction perpendicular to the recording layer of the recording medium.

4. The recording head according to claim 1, wherein the main magnetic pole has a leading side end surface that is positioned on a side of the main magnetic pole that is opposite to the trailing side end surface and tilts toward the leading side of the recording head with respect to the direction perpendicular to the recording layer of the recording medium.

5. The recording head according to claim 1, further comprising:
a junction part physically joining the main magnetic pole to the write shield magnetic pole, wherein the junction part includes an insulating layer electrically insulating the main magnetic pole from the write shield magnetic pole.

6. The recording head according to claim 1, further comprising:
side shields arranged on both sides of the main magnetic pole in a track width direction to be magnetically separated from the main magnetic pole.

7. The recording head according to claim 6, further comprising:
a leading shield magnetic pole that is disposed on a leading side of the main magnetic pole with a gap interposed therebetween and forms a magnetic circuit together with the main magnetic pole.

8. The recording head according to claim 1, further comprising:
a leading shield magnetic pole that is disposed on a leading side of the main magnetic pole with a gap interposed therebetween and forms a magnetic circuit together with the main magnetic pole.

9. The recording head according to claim 8, wherein the leading shield magnetic pole, the side shields, and the write shield magnetic pole are formed in an integrated manner.

10. A recording head, comprising:
a main magnetic pole that generates a recording magnetic field in a direction perpendicular to a recording layer of a recording medium;
a shield magnetic pole disposed on a trailing side of the main magnetic pole; and
a spin torque oscillator configured to generate a high frequency magnetic field and disposed between the main magnetic pole and the shield magnetic pole,
wherein the main magnetic pole has a side surface that faces the spin torque oscillator and is sloped with respect to an air bearing surface of the magnetic head, and the spin torque oscillator has one or more layers and the layers have surfaces that are sloped with respect to the air bearing surface of the magnetic head.

11. The recording head according to claim 10, wherein the side surface of the magnetic pole is closer to the air bearing surface of the magnetic head at a trailing end than a leading end.

12. The recording head according to claim 11, wherein the surfaces of the layers of the spin torque oscillator are substantially parallel to the side surface of the magnetic pole.

13. The recording head according to claim 11, further comprising:
a junction part physically joining the main magnetic pole to the shield magnetic pole, wherein the junction part includes an insulating layer electrically insulating the main magnetic pole from the shield magnetic pole.

14. The recording head according to claim 11, further comprising:
side shields arranged on both sides of the main magnetic pole in a track width direction to be magnetically separated from the main magnetic pole.

15. The recording head according to claim 14, further comprising:
a leading shield magnetic pole that is disposed on a leading side of the main magnetic pole with a gap interposed therebetween and forms a magnetic circuit together with the main magnetic pole.

16. The recording head according to claim 11, further comprising:
a leading shield magnetic pole that is disposed on a leading side of the main magnetic pole with a gap interposed therebetween and forms a magnetic circuit together with the main magnetic pole.

17. A disk device, comprising:
a recording medium including a magnetic recording layer having magnetic anisotropy in a direction perpendicular to a medium surface;
a driving part that rotates the recording medium; and
a recording head including a main magnetic pole that generates a recording magnetic field in a direction perpendicular to a recording layer of a recording medium, a shield magnetic pole disposed on a trailing side of the main magnetic pole, and a spin torque oscillator configured to generate a high frequency magnetic field and disposed between the main magnetic pole and the shield magnetic pole,
wherein the main magnetic pole has a side surface that faces the spin torque oscillator and is sloped with respect to an air bearing surface of the magnetic head, and the spin torque oscillator has one or more layers and the layers have surfaces that are sloped with respect to the air bearing surface of the magnetic head.

18. The disk device according to claim 10, wherein the side surface of the magnetic pole is closer to the air bearing surface of the magnetic head at a trailing end than a leading end.

19. The disk device according to claim 18, wherein the surfaces of the layers of the spin torque oscillator are substantially parallel to the side surface of the magnetic pole.

20. The disk device according to claim 19, further comprising:
side shields arranged on both sides of the main magnetic pole in a track width direction to be magnetically separated from the main magnetic pole; and
a leading shield magnetic pole that is disposed on a leading side of the main magnetic pole with a gap interposed therebetween and forms a magnetic circuit together with the main magnetic pole,
wherein the shield magnetic pole, the side shields, and the leading shield magnetic pole are formed in an integrated manner.
